(19) United States
(12) Patent Application Publication
(10) Pub. No.: US 2007/0162171 A1
(43) Pub. Date: Jul. 12, 2007

(54) METHOD FOR SUPPLIER COLLABORATION AND DATA ACCURACY

(75) Inventors: Stephen T. McDonald, Staatsburg, NY (US); Richard J. Lukes, Denver, NC (US); Michael T. Phelan, Milton, NY (US)

Correspondence Address: LAW OFFICE OF DELIO & PETERSON, LLC., 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/306,727

(22) Filed: Jan. 9, 2006

(51) Int. Cl. G06F 19/00

(52) U.S. Cl. 700/106; 705/29

(57) ABSTRACT

Methods, systems and apparatus for supplier collaboration and data accuracy within a materials requirement planning scenario. An external supplier is easily integrated into an inter-enterprise planning engine by generating uniquely modified external supplier input files that only include demand information, inventory coverage, and bills of material data associated with the external supplier. This modified external supplier data is used to integrate the external supplier into the planning engine, and for generating a requirements build that fulfills a build plan input into the planning engine. The planning engine is preferably an online planning engine, such that, the requirements build may be validated by inputting the most currently available supplier input data into the planning engine for generating a new, updated requirements build online substantially in real time for fulfilling the build plan.

### BACKGROUND OF THE INVENTION

1. Field of the Invention

The present invention is directed generally to materials requirement planning, and in particular, to methods, systems and apparatus for integrating an external supplier into an Inter-Enterprise Demand Materials Requirement Planning (MRP) Model for participating in the parts requirements planning environment, and for updating and/or correcting the planning results substantially in real time.

2. Description of Related Art

In today's business environment, the manufacture of large, mid-range, and client computer (e.g., desktop or mobile) products and technologies are continually and rapidly evolving. However, with these new technologies comes an increase in the rate of engineering changes in design developments. It is these engineering changes that cause high turnover rates in computer parts and products. When new parts or products are desired, an order request is made, and then a Materials Requirement Planning (MRP) tool is commonly used by the supplier enterprise for locating and gathering the required parts and/or components needed to build the desired end-product.

Within each supplier's inter-enterprise MRP system, batch data is bridged into the MRP from each of the supplier's manufacturing locations. This batch data may include, but is not limited to, bills of material, basic records, inventory, demand and coverage (on order and returns), as well as location parameters for suppliers, such as, frozen zones, transit times, order sizing rules, and the like. For example, FIG. 1 shows a conventional MRP process whereby an order decision is input and finalized (steps 10, 20) into the MRP. Also required from a variety of different suppliers are numerous batch data elements (steps 32) input from each supplier into the system for running the MRP (step 40) in order to fulfill and complete the order request (step 50).

External suppliers, such as, contract manufacturers, also bridge data into the inter-enterprise MRP for fulfilling the order request. By integrating external suppliers into an inter-enterprise MRP the cycle for fulfilling an order may be shortened, liability for the supplying party is reduced and one is able to obtain quick visibility to demand increases within the technology. However, with current MRP systems, the task of integrating an external supplier into the supplier's inter-enterprise MRP, for making such external supplier an integral part of the inter-enterprise MRP, is a costly and laborious task. In particular, each external supplier is required to input a number of mandatory data inputs 32 into the MRP, and then it generally takes months of I/T, business analysis and support services, classic design, and development and test resource activities to analyze and interpret the input external supplier data for determining what parts/products the external supplier had available at the time of inputting such data into the inter-enterprise MRP.

Further, once these MRP results are generated, it is also often necessary to perform a validation step (step 60) for validating any engineering change activity and/or correction of the MRP data in order to produce a valid forecast (step 70). However, this validation activity also requires extensive analysis and inventory corrections, which may ultimately result in missed planning and product-to-market opportunities, since updates and corrections cannot be made until the next MRP Planning Cycle run or rerun (steps 40′, 50′, 60′). As such, the conventional batch interface MRP driven applications are generally labor and system resource cumbersome, time consuming, expensive and inefficient, particularly when used for integrating an external supplier into an Inter-Enterprise MRP for fulfilling an order request and for timely validating the obtained results.

Accordingly, a need exists in the art for improved methods, systems and apparatus for integrating a supplier into an inter-enterprise MRP system for participating in the parts requirements planning environment, and for easily and quickly updating and/or correcting the resultant MRP data in a time efficient manner.

### SUMMARY OF THE INVENTION

Bearing in mind the problems and deficiencies of the prior art, it is therefore an object of the present invention to provide methods, systems and apparatus for integrating a supplier into an inter-enterprise MRP system for participating in the parts requirements planning environment, and for easily and quickly updating and/or correcting the resultant MRP data in a time efficient manner.

Another object of the present invention is to provide methods, systems and apparatus for integrating a supplier into an inter-enterprise MRP system, and for updating and/or correcting the resultant MRP data online in near real time.

It is another object of the present invention to provide methods, systems and apparatus for integrating a supplier into an inter-enterprise MRP system that allows the enterprise having the integrated supply chain to use data visibility to improve the demand signals.

A further object of the invention is to provide methods, systems and apparatus for integrating a supplier into an inter-enterprise MRP system that reduces human errors introduced into bill of materials data, thereby improving timing issues within a multi-tiered supply chain.

It is yet another object of the present invention to provide methods, systems and apparatus for integrating a supplier into an inter-enterprise MRP system that reduces excessive analysis and/or manual corrections, as well as reduces adjustments and/or corrections to the post planning cycle inventory record, thereby improving the MRP cycle run time.

Still another object of the present invention is to provide methods, systems and apparatus for integrating a supplier into an inter-enterprise MRP system that timely validates the MRP run results, which is cost effective and efficient.

Other objects and advantages of the invention will in part be obvious and will in part be apparent from the specification.

The above and other objects, which will be apparent to those skilled in art, are achieved in the present invention, which is directed to in a first aspect a method for materials requirement planning. The method includes providing a build plan and then inputting supplier input data into a planning engine, wherein selected ones of the supplier input data comprise external supplier input data of an external supplier. The external supplier input data is modified using logic of the planning engine to generate modified external supplier input files. These modified external supplier input files are then input into the planning engine for integrating the external supplier input data into the planning engine. A requirements build is then generated within the planning engine using the modified supplier input files for fulfilling the build plan. Preferably, the modified supplier input files include demand information, inventory coverage, and bills of material data associated with the external supplier.

In this aspect of the invention, the planning engine preferably comprises an inter-enterprise Materials Requirement Planning component. The external supplier is preferably a new supplier, such that, the modified external supplier input files establish this new supplier as being new integrated within the inter-enterprise planning engine. The step of inputting the supplier input data preferably includes the external supplier inputting a part number list of bills of material available from the external supplier into the planning engine. The part number list of bills of material is extrapolated for input into a supplier input table within the inter-enterprise planning engine. Logic of the inter-enterprise planning engine is then applied to the supplier input tables for generating the modified supplier input files. Additionally, default parameter files may be directly into the planning engine for generating the requirements build. These default parameter files may include controlling planning parameters including, but not limited to, frozen zones, order periods and horizons, reschedule rules and order delivery rules, cancellation metrics, and combinations thereof.

In accordance with the invention, the generated requirements build may then be validated manually or systematically by the planning engine itself. The generated requirements build may be validated by updating existing bills of material, sourcing data, safety stocks, inventory, orders, demands, default item basic data, and combinations thereof. The generated requirements build may be validated by inputting current supplier input data into the planning engine, and then inputting this data into the planning engine for updating the generated requirements build. A new requirements build is then generated based on the current supplier input data for fulfilling the build plan.

When validating the generated requirements build, if there are additional external suppliers that are to be newly integrated into the present planning engine, then new supplier input data for these additional suppliers is input into the planning engine. Logic of the planning engine then modifies this data to generate updated external supplier input files. The updated external supplier input files are into the planning engine for integrating the input data of the additional suppliers into the planning engine and for updating the generated requirements build. In so doing, a new requirements build is generated that is based on the updated external supplier input files for fulfilling the build plan.

In other aspect, the invention is directed to systems, program storage devices and computer program products for performing the method steps of the invention for supplier collaboration and data accuracy.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a prior art illustration of a conventional MRP process using batch supplier input data.

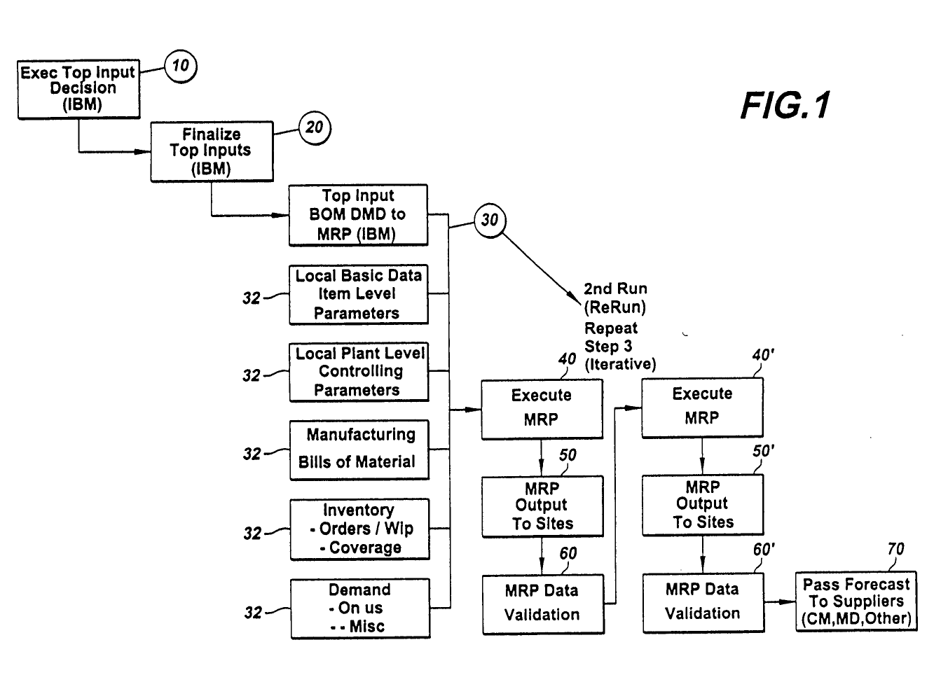

FIG. 2 is an overview of a supplier collaboration and data accuracy process flow of the invention.

FIG. 3 is a preferred supplier collaboration and data accuracy process flow of the invention.

FIG. 4 illustrates the system architecture of the invention for executing the present supplier collaboration and data accuracy processes.

### DESCRIPTION OF THE PREFERRED EMBODIMENT(S)

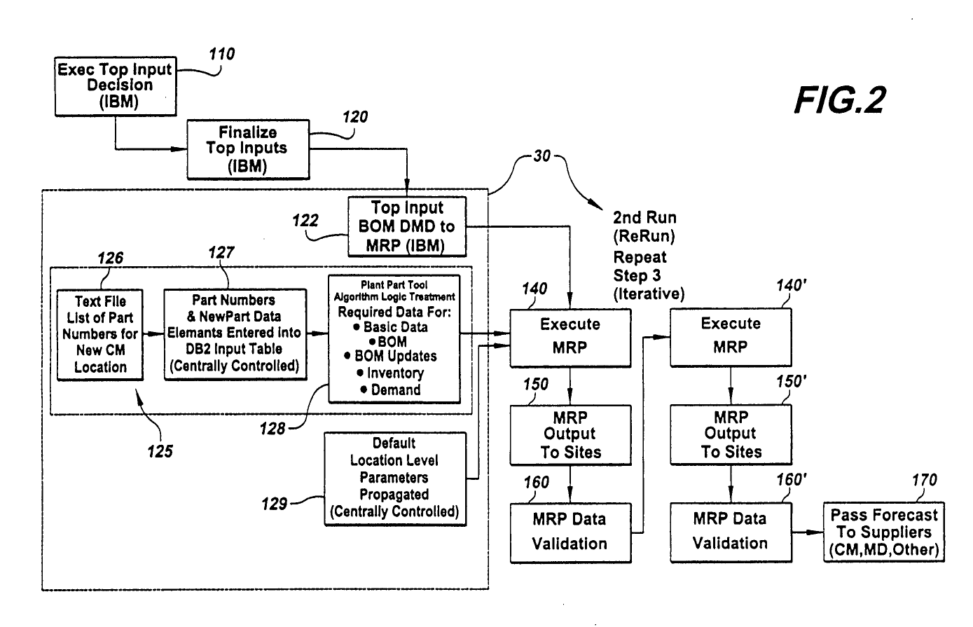

In describing the preferred embodiment of the present invention, reference will be made herein to FIGS. 2-4 of the drawings in which like numerals refer to like features of the invention.

The present invention solves the problems associated with conventional MRP systems by quickly and easily integrating a supplier into an inter-enterprise Materials Requirement Planning (MRP) system, and for enabling the updating and/or correction of the resultant MRP data online in near real time during the online MRP system session. The supplier is preferably an external supplier, such as, a contract manufacturer, that is to be newly integrated within the inter-enterprise MRP system for fulfilling order requests in a timely and cost effective manner.

For ease of understanding the invention, FIGS. 2-4 illustrates preferred embodiments of the present supplier collaboration and data accuracy invention. It should be appreciated that components of the invention may be embodied as a computer program product stored on a program storage device. These program storage devices may be devised, made and used as a component of a machine that utilizes optics, magnetic properties and/or electronics to perform certain of the method steps of the present invention. Such program storage devices may include, but are not limited to, magnetic media such as diskettes or computer hard drives, magnetic tapes, optical disks, Read Only Memory (ROM), floppy disks, semiconductor chips and the like. A computer readable program code means in known source code may be employed to convert certain of the method steps described below. This computer readable program code contains instructions embodied in tangible media, such as floppy disks, CD-ROMS, hard drives, or any other computer-readable storage medium, wherein, when the computer program code is loaded into and executed by a computer, the computer becomes an apparatus for practicing the invention.

Referring to FIG. 2, an overview of the present supplier collaboration and data accuracy invention is shown. Initially, an orderer decides upon selected parts and/or end-products to build (steps 110, 120), whereby a supplier, then provides the inputs to the customer/orderer controlling the MRP that then builds the data inputs into the supplier's online inter-enterprise MRP system (step 122). The build data may include information necessary for locating, gathering and building the desired parts and/or end-products, and as such, often includes information gathered from each of the supplier's manufacturing locations. However, this information is static since it only represents that build data currently available at the time the build data information is sent to the inter-enterprise MRP engine.

The present invention advantageously includes modified supplier input data files that are uniquely generated by the logic of the present MRP system for inputting into the online inter-enterprise MRP system during the MRP run. Preferably, these modified supplier input files are input into the MRP for the new external suppliers/supply locations for both integrating these external suppliers into the inter-enterprise MRP and for enabling the updating and/or correction of the resultant MRP data online in near real time. That is, the customer/orderer controlling the MRP may continuously input updated supplier input files (step 126) into the online system, on behalf of the supplier, substantially in real time, for updating the MRP results with new product/part availability information as it becomes available. In so doing, an essential feature of the invention is that these modified supplier input files only include critical data necessary for making the MRP/ERP system function and be able to explode parts requirements down to the next supplier tier, particularly based on the criticality of the supplier that is being integrated into the inter-enterprise MRP.

All other data needed for running an MRP is defaulted by the present MRP system into a default plant parameters file (step 129) within the inter-enterprise MRP system. This other data stored within the default plant parameters file includes the controlling planning parameters for the external supplier including, but not limited to, frozen zones, order periods and horizons, reschedule rules and other order delivery rules, cancellation metrics, and the like. In the invention, the parameters within the default plant parameters file are controlled and managed by the customer/orderer throughout the supply chain from an MRP parts planning perspective for contractually establishing the customer liability, and are updated directly in the MRP system operating system data directory.

In accordance with the invention, the critical data within the modified supplier input data files that is necessary for making the MRP/ERP system function preferably includes part/product demand information, inventory coverage, and bill of materials (BOM) data associated with the external supplier. In so doing, upon integrating a new external supplier into the inter-enterprise MRP system, this external supplier must submit a text file or spreadsheet that includes a part number list of part/product bill of materials available at the new external supplier location(s) (step 126). That is, the bill of material data is based upon a part number list input. This text file or spreadsheet of bill of materials must be supported in the central MRP in order to centrally integrate the new external supplier into the present inter-enterprise MRP model.

Once the supplier input files are input into the MRP system of the invention, logic of the present MRP expands and extrapolates the part number list of part/product bill of materials into a supplier input table within the present MRP system (step 127). In particular, the minimum data requirements for the bill of materials data is entered directly into a database input table via a Graphical User Interface (GUI). These database input tables are read by the MRP system for inclusion of the new external supplier into the inter-enterprise MRP. That is, the present MRP system has the ability to enter the supplier text file data into a new input table through the GUI, for identifying and assigning relationships between old part numbers to new part numbers. In particular, the present MRP allows for the entry of a “new part number”, an effective date, location, and it's associated “old” part number, such that, the MRP system is able to generate a default component and/or bill of materials record for the new part number, which is based on characteristics of the “old” part number.

Using this supplier input table (from step 127), logic of the present MRP system then generates the critical modified supplier input data files associated with the external supplier (i.e., the demand information, coverage, and bill of materials (BOM) data) in a pre-MRP step (step 128) for integrating such supplier, particularly a new external supplier, into the inter-enterprise MRP model. Further, the MRP system logic also expands upon the required data elements for establishing complete bills of materials and material master data. In so doing, certain data may be defaulted for the required tables in order to allow the location and associated bills of material and parametrics to be established within the MRP.

Upon the initial MRP run, the data within the supplier input tables (step 128) is input into the central planning system for running the MRP of the invention (step 140). The MRP determines which parts/products and the number of such parts/products needed to fulfill and complete an order. Also input into the central planning system for running the present MRP is the identified default parameter file for executing the MRP and fully integrating the external supplier into the present inter-enterprise MRP system.

Advantageously, the invention enables an external supplier to be integrated into an inter-enterprise MRP in one to four weeks, as compared to conventional batch techniques which often take up to six months to integrate an external supplier. Further, depending on the type of product, number of parts, number of suppliers building the same product, it is also feasible to construct the process where the customer/orderer maintains the bill of material data that depicts the supply chain. The selection of the part numbers throughout the supply chain can range from all that involve the customer-to-supplier relationship or to a very specific subset that just represents what the customer/orderer feels is important. As such, the invention allows for the customer/orderer to coordinate and implement the required changes, in order to generate a consistent and reliable demand throughout the supply chain.

The MRP results are generated and output (step 150) for validation (step 160) in a rerun validation process 130. In accordance with the invention, this validation step may be performed substantially in real time using the most up-to-date supply information. That is, the customer/orderer controlling the MRP may continuously input updated supplier input files into the online system, on behalf of the supplier, for updating the MRP results with new product/part availability information since the suppliers, particularly external suppliers, are able to continuously provide updates for their respective supplier input files with new information relating to those parts/products that are currently available within a near real time scenario. This is due to the part number lists, corrections and/or updates being entered into the system directly via the online MRP Application GUI for updating the MRP results online substantially in real time.

Thus, it is the combination of the input supplier files (step 126) and the conversion of such files into supplier input tables (step 127) that provide the capability of altering existing Bills of Material data (either new or existing) for addition, deletion and/or changes to the bill of material and its content (component parts), and updating sourcing data, stock, orders and/or demand, and the like, substantially in near real time, as compared to conventional batch MRPs which can often take numerous days to correct such information. These alterations may include changes, updates and/or corrections to the MRP data based on new or obsolete parts or components. The invention also allows the ability to provide update/adjustments to scheduling safety stock buffers, as well as the ability to assign multiple supply sources for a given part to multiple suppliers. Further, the invention allows for the identification of a new part number (component) on all effected bills of material for a particular external supplier/supplier location, changes the extract date on the existing bills of material with the new effective date as defined on the input table, thus making the new level bill of material either current or future effective depending on the defined date entered. The actual changes or updates to the MRP results for providing accurate inventory data results are performed by the logic of the present MRP system (step 128).

With customer satisfaction, inventory overages or missed revenue opportunities at stake, the invention enables the validation of the demand in an integrated online supply network and allows the customer, through supplier collaboration, to modify bill of material data centrally. This in turn results in demand at every level of the supply chain to be synchronized, without having every supplier change his data and resend, which would add excessive time to the multi tier demand explode process. Thus, data accuracy necessary for the need to respond to market changes and position the corporation at a competitive advantage, now has the ability to make changes to existing bills of material, add, delete and change bills of material, enter and provide the MRP system with stock data, order data and demand data online substantially in real time, without the need for system batch interfaces or dependency other upstream system applications. This allows for and positions the corporation to respond to new information in the market place on-demand and provide updates to the forecast online substantially in real time. The flexibility, adaptability, ease of use, and low cost installation of the invention is an innovative way for an external supplier to systematically integrate his supply chain and drastically reduce his time in informing all other suppliers, at every level, about demand changes.

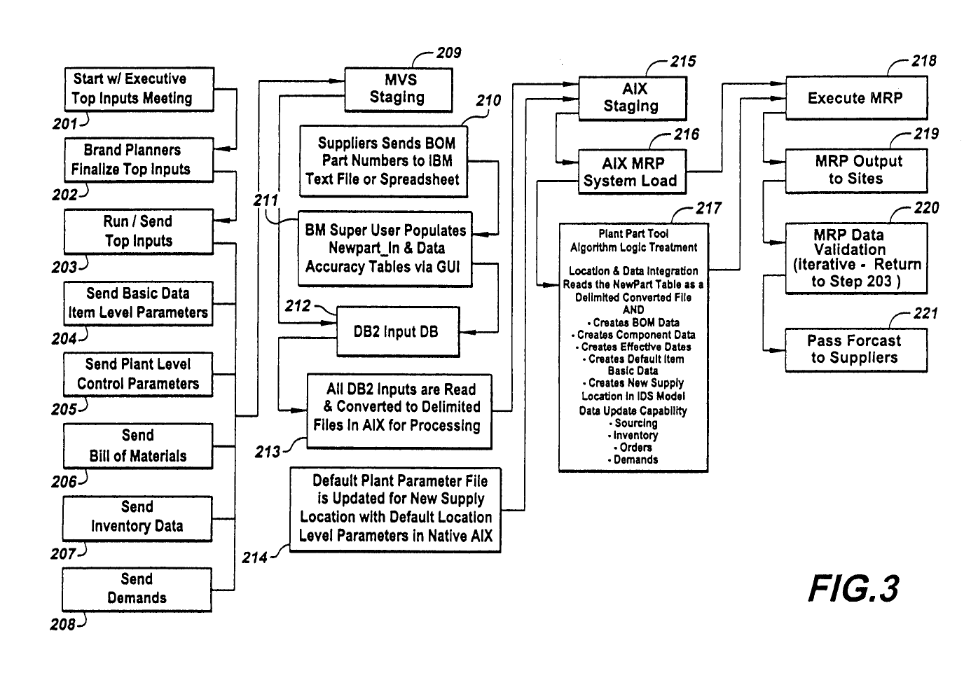

To better understand the invention, and not to limit it in any way, FIG. 3 shows a preferred supplier collaboration and data accuracy process flow of the invention. However, it should be appreciated and understood that many variations of such process flow may be made without deviating from the novel concepts of the invention for easily and quickly integrating an external supplier into an inter-enterprise MRP, and for timely validating such MRP results. The invention can be easily customized to fit any MRP/ERP system. Referring to FIG. 3, the process flow is as follows:

Step 201: The planning cycle of an enterprise begins by generating a build plan at an executive meeting between sales and manufacturing staff for determining which products to build. The process continues to step 202.

Step 202: Product and brand planners determine a master production schedule based upon the build plan for their respective products. The process continues to step 203.

Step 203: The product/brand manufacturing build plan is generated at a top bill of material level based upon the current customer order backlog and plan forecast data, and sent to the present MRP system. The process continues to step 209.

Step 204: Local interplant ordering and internal & external supply locations take a “snapshot” (i.e., availability at the time the order request is made and transmitted to the MRP) of their current material master records. This snapshot of available supplies is transmitted to the present inter-enterprise MRP system via a bridge interface or network staging area. The process continues to step 209.

Step 205: Local interplant ordering and internal & external supply locations take a “snapshot” of their current planning and ordering controlling site level parameters records (order periods, frozen zones, cancellation metrics, etc.), and transmit this data to the present inter-enterprise MRP system via a bridge interface. The process continues to step 209.

Step 206: Local interplant ordering and internal & external supply locations take a “snapshot” of their current manufacturing bill of material records (assembly and component level parts data), and transmit this data to the present inter-enterprise MRP system via a bridge interface. The process continues to step 209.

Step 207: Local interplant ordering and internal & external supply locations take a “snapshot” of their current inventory records (available stock, wip, forecast returns) for all parts data, and transmit this data to the present inter-enterprise MRP system via a bridge interface. The process continues to step 209.

Step 208: Local interplant ordering and internal & external supply locations take a “snapshot” of their current demand forecast (from customer orders, miscellaneous demands, component and other demand types) for all parts data, and transmit this data to the present inter-enterprise MRP system via a bridge interface. The process continues to step 209.

Step 209: The local interplant ordering and internal & external supply supplier inputs of master records, parameters records, current bill of material records, current inventory records and current demand forecast are all input into a network staging area, such as, a central MVS staging directory, for inputting into the present inter-enterprise MRP system. The process goes to step 212.

Step 210: An essential component of the invention is that new external suppliers/supply locations may be easily and quickly integrated within the inter-enterprise MRP. A new external supplier submits a text file or spreadsheet that includes a part number list of part/product bill of materials available at the new external supplier location(s). This step eliminates the necessary local freeze “snapshot” of data, development and lifecycle support maintenance of local interfaces at the cost of the new supply location, and allows the supplier to submit a basic part number list of part bill of materials that need to be supported in the central MRP for centrally integrating the new external supplier into the present MRP system. The process continues to step 211.

Step 211: The data within the new external supplier input files is then extrapolated and input into supplier input tables for use by the present MRP. The present centrally monitored and controlled MRP can then directly enter the minimum data requirements for the bill of materials data from these supplier input tables into a database of the present online MRP through a GUI.

In the event the MRP run is a rerun or validation process, this step also allows for the inclusion and entry of changes to existing Bills of Material, changes to Stock, Orders and Demands, as required, in order to provide accurate inventory data necessary for the MRP execution.

The process flow continues to step 212.

Step 212: The information from the central MVS staging directory from step 209, along with the supplier input tables from step 211, are input into a database of the present MRP system for storage and later use by the online MRP. The process continues to step 213.

Step 213: This step includes a system program process where all data contained in the MRP database of step 212 is received and converted into a readable file, such as from a relational file to a comma de-limited data file, for processing within the hosting network of the MRP in step 215. The host network may include any known hosting network that is capable of supporting the present inter-enterprise MRP, such as, an AIX staging system. The process continues to step 215.

Step 214: The present MRP system takes all other data input by the new external supplier that is needed to execute the MRP, and stores such information into a default plant parameters file within the inter-enterprise MRP system. The defaulted data includes controlling planning parameters for the external supplier, such as, supply information relating to frozen zones, order periods and horizons, reschedule rules and other order delivery rules, cancellation metrics, and the like. In so doing, the parameters within the default plant parameters file are controlled and managed centrally by the customer/orderer via a comma de-limited file, and updated directly in the MRP system AIX data directory. The process flow goes to step 215.

Step 215: The now readable file containing the supplier input table information is received within the hosting network of the MRP from step 213, along with information from the default plant parameters file from step 214. This data is staged within the hosting system directories, in readiness for the MRP process. The process continues to step 216.

Step 216: All data contained within the hosting system directories is now read into the present online MRP programs to begin the parts requirements generation and parts explosion process of the invention. In this step, an essential feature of the invention is that the data from the default plant parameters file is input directly into the MRP engine (go to step 218), while logic of the present MRP system is applied to the supplier input table information containing data relating to the supplier input files of plant/part/product bills of materials (go to step 217). The process continues to steps 217 and/or 218.

Step 217: At this point, prior to running the MRP, logic of the present MRP system is applied to the supplier input table information received from step 216 for generating the modified supplier input data files of the invention. These modified supplier input files include an identification of a new external supplier/supply location, and include part/product demand information, inventory coverage, and bill of materials (BOM) data associated with such new external supplier. In this manner, the modified supplier input files integrate a new external supplier into the inter-enterprise MRP model by establishing this new supplier/supply location as a new location within the MRP. The logic of the MRP system also expands upon the required data elements for establishing complete bills of materials and material master data. Additionally, the logic defaults certain data for the required tables in order to allow the location and associated bills of material and parametric to be established within the MRP.

Further, in the event the MRP run is a rerun or a validation step, this step through the applied logic of the present MRP system also provides the ability for the modified supplier input files to include updates to Bills of Material (new or existing) for addition, deletion or changes to the bill of material and its content (component part), as well as updates to sourcing data (e.g., effective dates), stocks or inventory (i.e., coverage and safety buffers), orders, demands, default item basic data, and the like for the now integrated suppliers. Additionally, even more new external suppliers may be integrated into the MRP at this point as discussed n detail above.

The process continues to step 218.

Step 218: The default plant parameters files from step 216, along with the modified supplier input files of the invention from step 217, are input into the inter-enterprise MRP engine for the MRP run. In so doing, the new external supplier/supply location is integrated within the inter-enterprise MRP for generating the MRP results. The process continues to step 219.

Step 219: The MRP results are then output to the internal and external sites. The process continues to step 220.

Step 220: Depending upon the MRP results, the internal and external sites may then decide to validate the MRP results. This may be done manually at the internal and external sites, or it may be performed systematically by the present MRP system to provide the most currently available MRP results. In the event the MRP results are to be validated, the process flow repeats back to step 203, and the process flow is repeated to include any updates and/or changes to supply availabilities for generating the updated MRP results that include substantially the most currently available supply/supplier information. If a validation step is not required, the process flow continues to step 221.

Step 221: The final MRP results, whether they are near real time or not, are then output to the suppliers for forecast commit back to ordering locations.

In accordance with the present invention, steps 210, 211, 214 and 217 substantially eliminate any need for I/T development or lifecycle support maintenance for data bridge interfaces, that in the past where required from the external suppliers to integrate into the planning process model. That is, these steps eliminate the need to perform the process steps of steps 204-209 of the above process flow when integrating new suppliers into an inter-enterprise MRP.

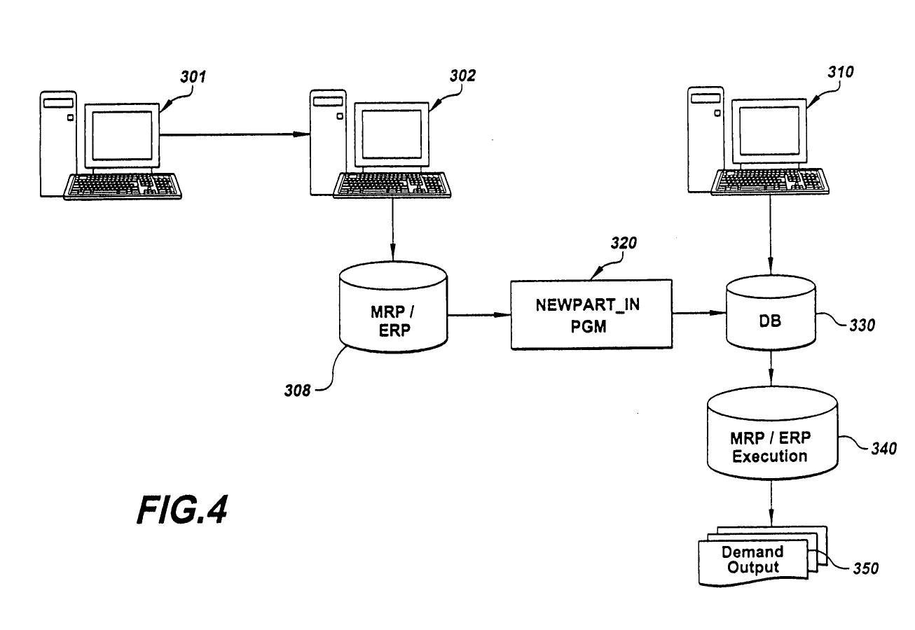

Referring to FIG. 4, system architecture of the invention is shown for executing the present supplier collaboration and data accuracy processes. An external supplier sends a part number list from his client computer 301 to another supplier's client computer 302 running an online inter-enterprise MRP system of the invention 308. Logic of the present online MRP system extrapolates the bills of material information from the external supplier's part number list and generates supplier input tables 320, which are entered directly into the database input table 330 of the MRP system via a Graphical User Interface (GUI). The invention also allows for manual demand information for a plant/part/product (safety stocks) for a new part number to be exported from another client computer 310 into a database of the MRP system prior to running the CPE/MRP, thereby enabling the manual demand information to be maintained centrally. The present MRP engine 340 than uses the information stored in its database to generate MRP results, which are output in demand output files 350. Again, these MRP results may then be validated and updated due to a number of changing factors that may affect the plant/part/product supplies, such as, engineering changes, changes in effective date, etc., such that, the updated MRP results may include the most currently available supply information gathered from suppliers, now integrated external suppliers, and even more newly integrated external suppliers, for generating near real time MRP results.

Thus, having described the invention, what is claimed is:

What is claimed is:

1. A method for materials requirement planning comprising:
providing a build plan;
inputting supplier input data into a planning engine, wherein selected ones of said supplier input data comprise external supplier input data of an external supplier;
modifying said external supplier input data using logic of said planning engine to generate modified external supplier input files;
inputting said modified supplier input files into said planning engine for integrating said external supplier input data of said external supplier into said planning engine; and
generating a requirements build within said planning engine using said modified supplier input files for fulfilling said build plan.

2. The method of claim 1 wherein said modified supplier input files include demand information, inventory coverage, and bills of material data associated with the external supplier.

3. The method of claim 1 wherein said planning engine comprises an online inter-enterprise planning engine.

4. The method of claim 3 wherein said external supplier comprises a new supplier, and said modified external supplier input files establishes said new supplier as being new integrated within said inter-enterprise planning engine.

5. The method of claim 1 wherein said step of inputting said supplier input data further comprises:
said external supplier inputting a part number list of bills of material available from said external supplier into said planning engine;
extrapolating said part number list of bills of material for input into a supplier input table within said planning engine; and
applying logic of said planning engine to said supplier input tables for generating said modified supplier input files.

6. The method of claim 5 wherein said step of applying logic to said supplier input tables further includes generating a default parameters file, and inputting said default parameters file directly into said planning engine for generating said requirements build.

7. The method of claim 6 wherein said default parameters file includes controlling planning parameters selected from the group consisting of frozen zones, order periods and horizons, reschedule rules and order delivery rules, cancellation metrics, and combinations thereof.

8. The method of claim 1 further including validating said generated requirements build.

9. The method of claim 8 wherein said generated requirements build are validated by updating planning requirements data selected from the group consisting of existing bills of material, sourcing data, safety stocks, inventory, orders, demands, default item basic data, and combinations thereof.

10. The method of claim 8 wherein said validation of said generated requirements build is performed manually by a user of said planning engine.

11. The method of claim 8 wherein said validation of said generated requirements build is performed systematically by said planning engine.

12. The method of claim 8 wherein said steps of validating said generated requirements build comprise:
inputting current supplier input data into said planning engine;
inputting said current supplier input data into said planning engine for updating said generated requirements build; and
generating a new requirements build based on said current supplier input data for fulfilling said build plan.

13. The method of claim 8 wherein said external supplier comprises a new supplier, and said steps of validating said generated requirements build comprise:
inputting current supplier input data into said planning engine, wherein selected ones of said current supplier input data comprise new supplier input data of additional new external suppliers;
inputting said new supplier input data into said planning engine;
modifying said new supplier input data using said logic of said planning engine to generate updated external supplier input files;
inputting said updated external supplier input files into said planning engine for integrating said new supplier input data of said additional new external suppliers into said planning engine and for updating said generated requirements build; and
updating said requirements build by generating a new requirements build based on said updated external supplier input files for fulfilling said build plan.

14. The method of claim 8 wherein said planning engine comprises an online planning engine for validating said generated requirements build online substantially in real time.

15. A system for materials requirement planning for supplier collaboration and data accuracy comprising:
a build plan;
an online planning engine;
an input table of said online planning engine including external supplier input data of at least one external supplier;
a modified external supplier input file comprising unique supplier input data generated by modifying said external supplier input data using logic of said online planning engine;
a program of said online planning engine for generating a requirements build using said modified external supplier input file for fulfilling said build plan.

16. The system of claim 15 further including a default parameters file for inputting into said online planning engine, whereby said program uses said modified external supplier input file in combination with said default parameters file for generating said requirements build.

17. The system of claim 15 wherein said modified external supplier input file includes demand information, inventory coverage, and bills of material data associated with said external supplier.

18. The system of claim 15 wherein said online planning engine comprises an inter-enterprise Materials Requirement Planning engine.

19. The system of claim 15 further including additional logic within said online planning engine for validating said generated requirements build.

20. The system of claim 19 wherein said online planning engine is adapted for generating said requirements build and for validating said generated requirements build online substantially in real time.

21. A program storage device readable by a processor capable of executing instructions, tangibly embodying a program of instructions executable by the processor to perform method steps for materials requirement planning, said method steps comprising:
providing a build plan;
inputting supplier input data into a planning engine, wherein selected ones of said supplier input data comprise external supplier input data of an external supplier;
modifying said external supplier input data using logic of said planning engine to generate modified external supplier input files;
inputting said modified supplier input files into said planning engine for integrating said external supplier input data of said external supplier into said planning engine; and
generating a requirements build within said planning engine using said modified supplier input files for fulfilling said build plan.

22. The program storage device of claim 21 wherein said method step of inputting said supplier input data further comprises:
said external supplier inputting a part number list of bills of material available from said external supplier into said planning engine;
extrapolating said part number list of bills of material for input into a supplier input tables within said inter-enterprise planning engine; and
applying logic of said inter-enterprise planning engine to said supplier input tables for generating said modified supplier input files.

23. The program storage device of claim 21 wherein said method steps further comprise validating said generated requirements build.

24. The program storage device of claim 23 wherein said method steps of validating said generated requirements build comprise:
inputting current supplier input data into said planning engine;
inputting said current supplier input files into said planning engine for updating said generated requirements build; and
generating a new requirements build based on said current supplier input data for fulfilling said build plan.

25. The program storage device of claim 23 wherein said method steps of validating said generated requirements build comprise:
inputting current supplier input data into said planning engine, wherein selected ones of said current supplier input data comprise new supplier input data of additional new external suppliers;
inputting said new supplier input data into said planning engine;
modifying said new supplier input data using said logic of said planning engine to generate updated external supplier input files;
inputting said updated external supplier input files into said planning engine for integrating said new supplier input data of said additional new external suppliers into said planning engine and for updating said generated requirements build; and
updating said requirements build by generating a new requirements build based on said updated external supplier input files for fulfilling said build plan.

26. A computer program product comprising:
a computer usable medium having computer readable program code means embodied therein for materials requirement planning, said computer program product having:
computer readable program code means for causing a computer to input supplier input data into a planning engine, wherein selected ones of said supplier input data comprise external supplier input data of an external supplier;
computer readable program code means for causing a computer to modify said external supplier input data using logic of said planning engine to generate modified external supplier input files;
computer readable program code means for causing a computer to input said modified supplier input files into said planning engine for integrating said external supplier input data of said external supplier into said planning engine; and
computer readable program code means for causing a computer to generate a requirements build within said planning engine using said modified supplier input files for fulfilling a build plan.

27. The computer program product of claim 26 wherein said computer program product further includes:
computer readable program code means for causing a computer to receive an input part number list of bills of material available from said external supplier into said planning engine;
computer readable program code means for causing a computer to extrapolate said part number list of bills of material for input into a supplier input tables within said inter-enterprise planning engine; and
computer readable program code means for causing a computer to apply logic of said inter-enterprise planning engine to said supplier input tables for generating said modified supplier input files.

28. The computer program product of claim 26 further including computer readable program code means for causing a computer to validate said generated requirements build.

29. The computer program product of claim 28 wherein said computer program product further includes:
computer readable program code means for causing a computer to receive current supplier input data input into said planning engine;
computer readable program code means for causing a computer to input said current supplier input files into said planning engine for updating said generated requirements build; and
computer readable program code means for causing a computer to generate a new requirements build based on said current supplier input data for fulfilling said build plan.

30. The computer program product of claim 28 wherein said computer program product further includes:
computer readable program code means for causing a computer to receive current supplier input data input into said planning engine, wherein selected ones of said current supplier input data comprise new supplier input data of additional new external suppliers;
computer readable program code means for causing a computer to input said new supplier input data into said planning engine;
computer readable program code means for causing a computer to modify said new supplier input data using said logic of said planning engine to generate updated external supplier input files;
computer readable program code means for causing a computer to input said updated external supplier input files into said planning engine for integrating said new supplier input data of said additional new external suppliers into said planning engine and for updating said generated requirements build; and
computer readable program code means for causing a computer to update said requirements build by generating a new requirements build based on said updated external supplier input files for fulfilling said build plan.
